(19) United States
(12) Patent Application Publication
(10) Pub. No.: US 2024/0238727 A1
(43) Pub. Date: Jul. 18, 2024

(54) SYSTEMS AND METHODS FOR REDUCING MAGNESIUM, CALCIUM, AND/OR SULFATE FROM SODIUM CHLORIDE BRINE DURING CONCENTRATION BY HIGH-PRESSURE NANLFILTRATION

(71) Applicant: FLUID TECHNOLOGY SOLUTIONS (FTS), INC., Albany, OR (US)

(72) Inventor: John R. Herron, Corvallis, OR (US)

(21) Appl. No.: 18/560,199

(22) PCT Filed: Mar. 1, 2022
(86) PCT No.: PCT/US2022/018350

§ 371 Date: Nov. 10, 2023

Related U.S. Application Data
(60) Provisional application No. 63/155,494, filed on Mar. 2, 2021.

(51) Int. Cl. B01D 61/02; C02F 1/44; C02F 101/10; C02F 103/08

(52) U.S. Cl. CPC B01D 61/029; B01D 61/026; B01D 61/0271; C02F 1/441; C02F 1/442; B01D 2311/06; B01D 2311/08; B01D 2317/022; B01D 2317/025; B01D 2317/08; C02F 2101/101; C02F 2103/08; C02F 2301/08

(57) ABSTRACT

Systems and methods for reducing at least one of magnesium, calcium and/or sulfate from sodium chloride brine are described. Systems and methods include nanofiltrating seawater to reduce calcium, magnesium, and sulfate therein. Systems and methods also include introducing permeate from the nanofiltration step as a feed to reverse osmosis (RO) followed by a progressive nanofiltration array. Systems and methods also include feeding the lower salinity permeate from the introducing permeate step to another RO system. Systems and methods also include feeding retentate from the feeding step to a progressive nanofiltration system that concentrates the brine to an appropriate salinity.

### CROSS-REFERENCE TO RELATED APPLICATIONS

This application claims priority to U.S. Provisional Patent Application No. 63/155,494 filed on Mar. 2, 2021, the disclosure of which is incorporated herein, in its entirety, by this reference.

### BACKGROUND

Purification and concentration of salt brines is often required for industries such as chlor-alkali. Typically, purification is achieved chemically by processes such as softening, and dewatering is performed by evaporation. These processes are energy, chemical, waste, and capital intensive. The chlor-alkali industry requires sodium chloride feed solutions in excess of 250 part per thousand (ppt) with low levels of magnesium calcium, and sulfate. Removal of calcium and magnesium from the brine typically is achieved by the addition of Na₂CO₃ to form CaCO₃ solid, followed by the addition of NaOH to form Mg(OH)₂ solid. The solution must be filtered and acidified with HCl before use and a large amount of sludge is formed. Alternately, Ca and Mg can be removed by crystallization, but this requires expensive, energy consuming equipment, loses a portion of the NaCl, and produces a concentrated waste brine.

A membrane process for achieving high salt brines was described in U.S. Published Patent Application No. 20150014248 filed 11 Jul. 2014 to Herron, Beaudry and Lampi (Herron Membrane Process), which is incorporated herein, in its entirety, by this reference. The Herron Membrane Process is like reverse osmosis (RO) in that it uses high pressure to force water through a semipermeable membrane. RO is limited in the amount of water it can remove since commercial membrane systems are limited to pressures of at most 120 bar due to materials issues. This pressure can at most produce a 110 ppt NaCl solution because of the osmotic pressure of the solution. The membrane and process in the Herron Membrane Process uses a more permeable nanofiltration membrane that allows salt to slowly permeate through the membrane, which creates a saline permeate. The osmotic potential of salt on the permeate side allows more water to be forced from the feed solution so that the difference in osmotic pressures between the feed and the permeate is equal to the applied pressure.

It was proposed that a salt solution be dewatered as much as possible with RO then the RO retentate be fed to a series of nanofiltration elements at high pressure to produce a final retentate with osmotic pressures far above the applied pressure. The saline permeate is substantially less salty than the retentate, so the permeate can be dewatered by RO or returned to the feed of the nanofiltration elements.

The process of high pressure nanofiltration to concentrate salt brines, discussed in the Herron Membrane Process, is incorporated herein, in its entirety, by this reference. The Herron Membrane Process describes the equipment and transport equations pertinent to the concentration of single component brines to osmotic pressures higher than the applied osmotic pressure.

An additional provisional patent application No. 63/150,772 filed on 18 Feb. 2021 by Herron, Beaudry and Lampi which describes energy and equipment savings by the appropriate reinjection of nanofiltration permeate is also incorporated, in its entirety, by reference.

The high-pressure nanofiltration process can also be used to purify salt streams. Of particular interest to the chlor-alkali industry, is the separation of calcium, magnesium, and sulfate impurities from high concentration sodium chloride solutions. In the nanofiltration process, divalent cations such as Ca⁺⁺, Mg⁺⁺ and SO₄⁻ permeate the membrane much more slowly than monovalent cations such as Na⁺ and Cl⁻ so during the process, the ratio of divalent to monovalent cations increases in the retentate and decreases in the permeate. This has been applied to the reduction of magnesium in brines for the solar evaporation harvesting of lithium from salar ponds. A PCT International Patent Application No. PCT/US2020/058879 filed on 4 Nov. 2020 directed to the above subject matter is incorporated herein, in its entirety, by this reference.

Concentration and purification of brines for the chlor-alkali industry is a useful example of the benefits of the process. In the Middle East, electricity costs are low and numerous seawater desalination installations produce large amounts of brine which are expensive to dispose of. It has been proposed to concentrate the desalination brine to use as a feed to chlor-alkali plants. Further concentration of the brine has the added benefit of recovering more water from the seawater.

Removal of calcium, magnesium and sulfate from chlor-alkali feed brine is valuable in that it reduces fouling of chlor-alkali electrocells and reduces the amount of concentrated NaCl brine that must be purged.

### SUMMARY

Embodiments disclosed herein are directed to a three step combination of nanofiltration and reverse osmosis that can concentrate seawater or other mixed salt streams to high concentrations with low levels of calcium, magnesium and sulfate.

In one or more embodiments, a method of producing desalinated seawater includes nanofiltrating seawater to reduce calcium, magnesium, and sulfate therein, introducing permeate from the nanofiltration step as a feed to reverse osmosis followed by a progressive nanofiltration array, feeding the lower salinity permeate from the introducing permeate step to another reverse osmosis (RO) system, and feeding retentate from the feeding step to a progressive nanofiltration system that concentrates the brine to an appropriate salinity.

More particularly, the first step of the process includes nanofiltration of seawater to reduce calcium, magnesium, and sulfate. Numerous species such as strontium, phosphate, and silica are also reduced, but they are of less importance to the quality of the chlor-alkali brine extracted from seawater.

The second step is the introduction of the permeate from the first step as the feed to reverse osmosis followed by a progressive nanofiltration array. The second step feed is concentrated to a small volume of high strength brine with a high proportion of divalent ions. The permeate from the second step nanofiltration membranes becomes the feed to the third step. Water from the RO membranes is suitable for industrial or municipal use.

The third step feeds the lower salinity permeate from the second step nanofiltration to another RO system. The retentate from the step three RO is fed to a progressive nanofiltration system which concentrates the brine to an appropriate salinity. Permeate from the step three nanofiltration elements, as well as the high salinity permeate from step two nanofiltration, are fed to either the step three RO or to appropriate places in the step three nanofiltration train.

In an embodiment, a method of producing desalinated seawater includes nanofiltrating seawater to reduce calcium, magnesium, and sulfate therein. The method includes introducing permeate from the nanofiltration step as a feed to a first reverse osmosis system followed by a first progressive nanofiltration array, thereby forming a lower salinity permeate and a higher salinity permeate having a salinity greater than the lower salinity permeate. The method includes feeding the lower salinity permeate to a second RO system, thereby forming a retentate. The method includes feeding the retentate from the second RO system to a second progressive nanofiltration system that concentrates brine in the retentate to within at least a predetermined salinity.

In an embodiment, a system for reducing at least one of magnesium, calcium and/or sulfate from sodium chloride brine is disclosed. The system includes a first NF system positioned to receive at least filtered seawater fed by a pump, and configured to produce a first retentate and a first permeate. The system includes a first RO system positioned to be fed the first permeate from the first NF system and configured to produce at least a second retentate and desalinated water. The system includes a second NF system positioned to be fed the second retentate from the first RO system and configured to produce one or more additional permeates. The system includes a second RO system positioned to be fed at least one permeate of the one or more additional permeates from the second NF system to produce at least a fourth retentate and additional desalinated water. The system includes a third NF system positioned to be fed at least the fourth retentate from the second RO system to produce one or more further permeates and a final retentate that is substantially free of divalent ions.

In an embodiment, a method for reducing at least one of magnesium, calcium and/or sulfate from sodium chloride brine is disclosed. The method includes feeding at least filtered seawater to a first NF system, thereby producing a first retentate and a first permeate. The method includes feeding the first permeate from the first NF system to a first RO system, thereby producing at least a second retentate and desalinated water. The method includes feeding the second retentate from the first RO system to a second NF system, thereby producing one or more additional permeates. The method includes feeding at least one permeate of the one or more additional permeates from the second NF system to a second RO system, thereby producing at least a fourth retentate and additional desalinated water. The method includes feeding at least the fourth retentate from the second RO system to a third NF system, thereby producing one or more further permeates and a final retentate that is substantially free of divalent ions.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the present disclosure, wherein identical reference numerals refer to identical or similar elements or features in different views or embodiments shown in the drawings.

FIG. 1 is a schematic of a first step of systems and methods for reducing one or more of magnesium, calcium and/or sulfate from sodium chloride brine, according to an embodiment.

FIG. 2 is a schematic of a second step of systems and methods for reducing one or more of magnesium, calcium and/or sulfate from sodium chloride brine, according to an embodiment.

FIG. 3 is a schematic of a third step of systems and methods for reducing one or more of magnesium, calcium and/or sulfate from sodium chloride brine, according to an embodiment.

### DETAILED DESCRIPTION

Embodiments disclosed herein are related to systems and methods for reducing one or more (e.g., all) of magnesium (Mg), calcium (Ca), and/or sulfate (SO₄) from sodium chloride (NaCl) brine during concentration by high-pressure nanofiltration. In at least one, some, or all embodiments, a combined, three-stage, nanofiltration (NF)/reverse osmosis (RO) system separates a mixed salt solution (e.g. feed solution) into water, streams of combined mixed salts, and a concentrated salt solution substantially free of divalent ions. The feed solution is seawater, according to an embodiment. The concentrated salt solution that is substantially free of divalent ions results in the technical of effect of providing feedstock for industrial processes and/or the chlor-alkali industry.

In at least one, some, or all embodiments, a method of producing desalinated seawater includes nanofiltrating seawater to reduce calcium, magnesium, and sulfate therein. The method also may include introducing permeate from the nanofiltration step as a feed to reverse osmosis followed by a progressive nanofiltration array. The method also may include feeding the lower salinity permeate from the introducing permeate step to another RO system. The method also may include feeding retentate from the feeding step to a progressive nanofiltration system that concentrates the brine to an appropriate salinity.

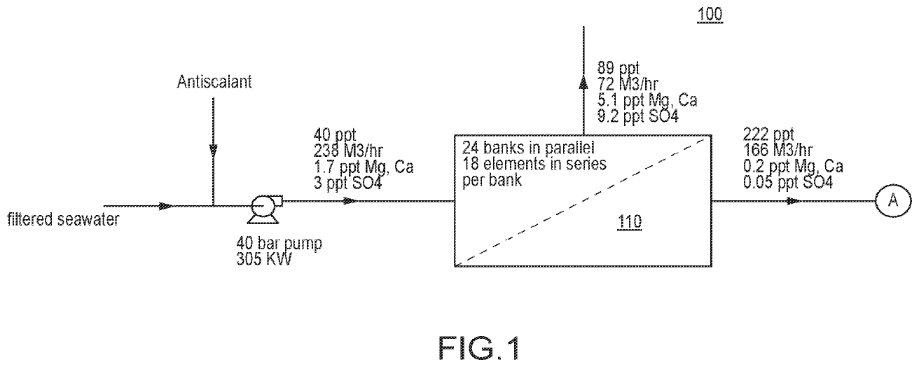

FIGS. 1-3 are schematics of a system and method for reducing one or more (e.g., all) of magnesium, calcium, and/or sulfate from sodium chloride brine during concentration by high-pressure nanofiltration, according to an embodiment. FIGS. 1-3 are based on standard modeling of RO systems, such as the RO system analysis (ROSA) model and internal models of the performance of high-pressure nanofiltration elements developed by Fluid Technology Solutions (FTS) of Albany, Oregon USA. In some embodiments, the high-pressure nanofiltration elements may include a range of sodium ion permeabilities, but the ratio of permeabilities of different species may remain relatively constant for all membranes. The species approximate relative ratios of permeability for membranes in the high-pressure nanofiltration elements is shown below in Table 1, according to at least one, some, or all embodiments. Chloride is poorly rejected, and in the model, it is assumed to move to maintain electrical neutrality.

TABLE 1
Relative ratios of permeability for membranes
in high-pressure nanofiltration elements

| Species | Relative Permeability |
|---|---|
| Potassium | about 300 |
| Sodium | about 200 |
| Calcium | about 10 |
| Magnesium | about 4 |
| Sulfate | about 1 |

The model of the behavior of multiple species can predict the behavior of only two species (along with chloride). The modeling procedure was to first to estimate the removal of sulfate by treating all cations as sodium. This analysis showed sulfate is largely removed in the first step and the modeling was performed by ignoring sulfate, lumping sodium and potassium, calcium and magnesium, and modeling the water as a two-cation solution. The model also assumes that nanofiltration elements are selected with permeabilities that provide a constant flux of 10 liters/m²/hr (lmh). It was assumed that all elements are 8040 spiral wound design with 40 m² membrane.

FIG. 1 is a schematic of a first step 100 of nanofiltration (NF) of prefiltered Arabian Gulf seawater, according to an embodiment. In some embodiments, the first step 100 includes nanofiltration of seawater to reduce calcium, magnesium, and sulfate. Numerous species such as strontium, phosphate, and silica are also reduced, but they may be of less importance to the quality of the chlor-alkali brine extracted from seawater.

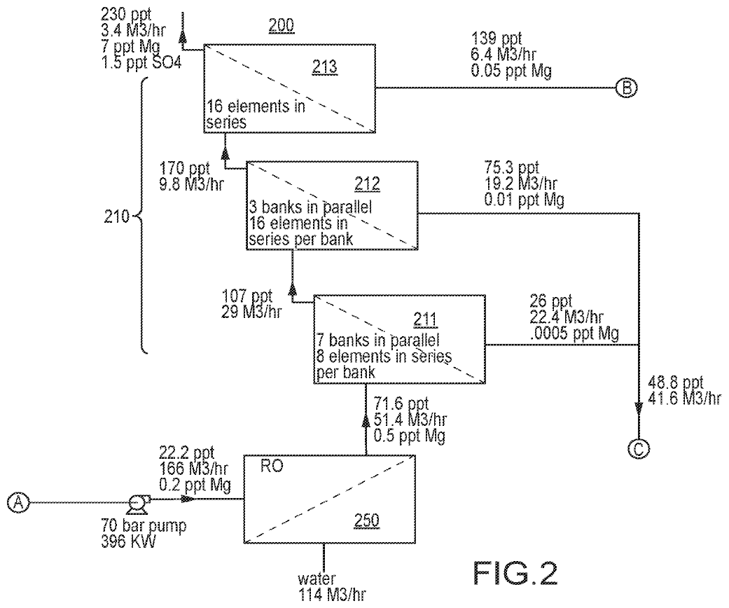

In at least one, some, or all embodiments, an antiscalant is added to the seawater, and the resulting initial solution is fed to banks of NF elements operating at 40 bar pressure in a first NF system 110 that produces a retentate (e.g., a concentrate) and a first permeate (A). The antiscalant may include a dianionic polyelectrolyte (DAPE), such as poly[disodium 3-(N,N-diallylamino)propanephosphonate. The retentate from the first NF system 110 is high in divalent ions and is disposed of. The first permeate (A) from the first NF system 110 passes on to a second step 200 of the process, shown in FIG. 2.

In an example, the schematic modeled in FIG. 1 was initially run with 238 m³/hr feed with 36 parts per thousand (ppt) NaCl and 4 ppt Na₂SO₄ to estimate the amount of sulfate which permeated the membrane. It was assumed that the system was operated at 40 bar. The model showed little sulfate crossed the membrane, so sulfate was ignored in the subsequent membrane processes.

The schematic modeled in FIG. 1 was run a second time with about 238 m³/hr feed, about 33 ppt NaCl, and about 7 ppt MgCl₂ to simulate the combined effect of calcium and magnesium. In this implementation, the first retentate in FIG. 1 is concentrated by the nanofiltration process to a flow (e.g., of about 72 m³/hr) and a salinity of about 89 parts per thousand (ppt), according to an embodiment. The lumped Ca and Mg concentration rose from about 1.7 in the initial solution to about 5.1 ppt in the first retentate, and the sulfate rose from about 3 in the initial solution to about 9.2 ppt in the first retentate, according to an embodiment. The first permeate (A) from the first NF system 110 had a salinity of 22.2 ppt, a flow of about 166 m³/hr, about 0.2 ppt divalent cations (e.g., of Mg and Ca), and negligible sulfate, according to an embodiment. The first retentate leaves the process and the first permeate (A) continues to a second step 200, shown in FIG. 2.

Turning now to FIG. 2, a schematic of the second step 200 of systems and methods includes a first RO system 250 and a subsequent second NF system 210 for processing the first permeate (A) formed according to FIG. 1. In some embodiments, the second step 200 may include the introduction of the permeate (A) from the first step 100 as the feed to reverse osmosis followed by a progressive nanofiltration array. The second step 200 feed may be concentrated to a small volume of high strength brine with a high proportion of divalent ions. The permeate from the second step 200 nanofiltration membranes may become the feed to the third step. Water from the RO membranes is suitable for industrial or municipal use.

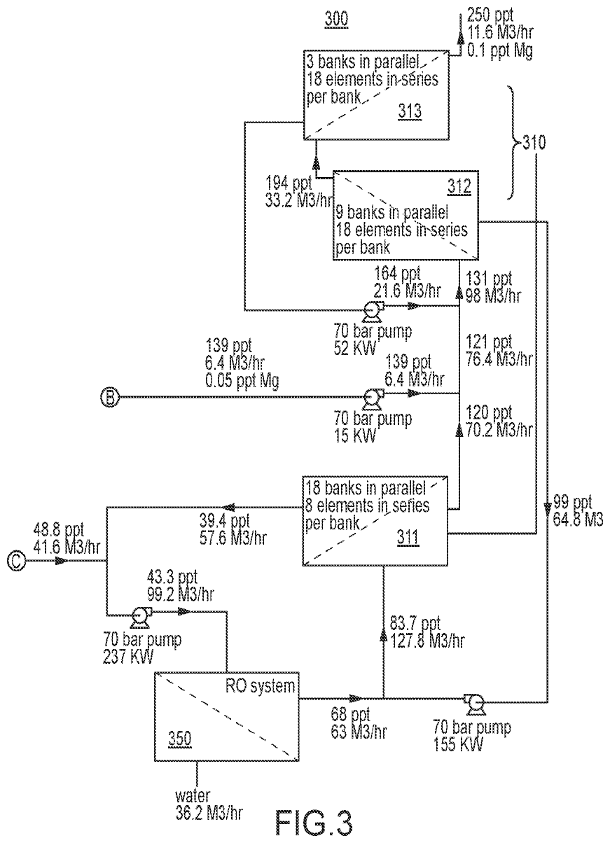

FIG. 2 picks up the first permeate (A) from the first NF system 110 in FIG. 1, and concentrates the first permeate (A) as much as possible with the first RO system 250 to form a second retentate. The second retentate from the first RO system 250 of the second step 200 is then passed through successive arrays or banks of NF membranes in the second NF system 210 until a small volume of third retentate is left with high divalent ion concentrations. The third retentate is disposed of and a second permeate (B) and a third permeate (C) is passed on to a third step 300 shown in FIG. 3.

More specifically, the second step 200 starts with the first permeate (A) from the first step 100 pumped (e.g., at about 70 bar) to the first RO system 250, which produces water or other solution (e.g., about 114 m³/hr of water), according to an embodiment. The flow of the second retentate from the first RO system 250 may be about 51.4 m³/hr and have salinity higher (e.g., 71.6 ppt) than the first permeate (A) fed to the first RO system 250, according to an embodiment. The second NF system 210 of the second step 200 passes the second retentate from the first RO system 250 through multiple (e.g., three) arrays of NF elements, according to an embodiment. The first array 211 of NF elements in the second NF system 210 may include 7 banks in parallel with 8 elements per bank. The second array 212 of NF elements in the second NF system 210 may include three banks in parallel, each having 16 elements in series. The third array 213 of NF elements in the second NF system 210 may include a single bank of 16 elements in series.

The first array 211 of NF elements in the second NF system 210 produces a retentate that leaves (e.g., at about 29 m³/hr) the first array 211 of NF elements in the second NF system 210 having a higher salinity (e.g. about 107 ppt) than the second retentate fed into the first array 211 of NF elements in the second NF system 210. The second array 212 of NF elements in the second NF system 210 produces a retentate that leaves (e.g., at about 9.8 m³/hr) the second array 212 of NF elements in the second NF system 210 having a higher salinity (e.g., about 170 ppt) than the retentate from the first array 211 of NF elements in the second NF system 210 that is fed to the second array 212 of NF elements in the second NF system 210. The third array 213 of NF elements in the second NF system 210 produces a third retentate that leaves (e.g., at about 3.4 m³/hr) the third array 213 of NF elements in the second NF system 210 having a salinity (e.g., 230 ppt) higher than the retentate from the second array 212 of NF elements in the second NF system 210 that is fed to the third array 213 of NF elements in the second NF system 210. The level of Mg (e.g., 7 ppt) in the third retentate may be at least 5 times, at least 10 times, or at least 15 times greater than the level of Mg (0.5 ppt) in the second retentate fed into the second NF system 210. Substantially all of the sulfate (e.g., at least about 75%, at least about 90%, or at least about 99% of the sulfate) which permeated the first NF system 110 (e.g., in the first permeate) in the first step 100 is in the third retentate.

The permeate from the first array 211 of NF elements in the second NF system 210 and the permeate from the second array 212 of NF elements in the second NF system 210 are combined to produce an third permeate (C) having a flow (e.g., of about 41.6 m³/hr) and a salinity (e.g., about 48.8.ppt) higher than the salinity (about 22.2 ppt) of the first permeate fed into the first RO system 250 but lower than the salinity (about 71.6 ppt) fed into the first array 211 of NF elements of the second NF system 210. The permeate from the first array 211 of NF elements in the second NF system 210 may have a lower salinity (e.g., 26 ppt) than the salinity (e.g., about 75.3) of the permeate from the second array 212 of NF elements to which the permeate from the first array 211 of NF elements is combined. The second permeate (B) from the third array 213 of NF elements of the second NF system 210 is produced (e.g., about 6.4 m³/hr) having a higher salinity (e.g., 139 ppt) than the third permeate, as well as a higher salinity than the second retentate fed into the first array 211 of NF elements in the second NF system 210. Both the second permeate (B) and the third permeate (C) streams are passed to the third step 300 the process, shown in FIG. 3.

Turning now to FIG. 3, a schematic of the third step 300 of systems and methods includes a second RO system 350 and a subsequent third NF system 310 for processing the second permeate (B) and the third permeate (C) formed according to FIG. 2. In some embodiments, the third step 300 feeds the lower salinity permeate from the second step 200 nanofiltration to another RO system. The retentate from the step three 300 RO may be fed to a progressive nanofiltration system which concentrates the brine to an appropriate salinity. Permeate from the step three 300 nanofiltration elements, as well as the high salinity permeate from step two nanofiltration, are fed to either the step three 300 RO or to appropriate places in the step three nanofiltration train, according to an embodiment.

More specifically, FIG. 3 shows second RO system 350 followed by the third NF system 310 for producing a final retentate or concentrate (e.g., at 250 ppt) that is low in divalent ions (e.g., about or less than 0.1 ppt Mg). In some embodiments, the concentration of divalent ions in the initial solution may be at least 5 times, at least 10 times, or at least 15 times greater than the concentration of divalent ions in the final retentate. Feed water to the second RO system 350 comes from the third permeate (C) that has a lower salinity (e.g., 48.8) than the salinity (e.g., 139 ppt) of the second permeate (B). Feed water to the second RO system 350 also may come from another permeate from the third NF system 310, as described in greater detail below, and also may have a lower salinity (e.g., about 39.4 ppt) than the second permeate (B). A fourth retentate from the second RO system 350 in the third step 300 is passed through a series of NF banks of the third NF system 310, and the permeate streams from this third NF system 310 may be reintroduced to one or more of the second RO system 350 and/or the third NF system 310 at appropriate or preselected places. The second permeate (B) from the second step 200 has more saline than the third permeate (C) and is also injected into the third NF system, according to an embodiment. The systems and methods described herein result in the technical effect of producing water produced in the second step 200 and a third step 300 of FIG. 3 that is high quality desalinated seawater.

In some embodiments, the third step 300 of FIG. 3 combines the low salinity, third permeate (C) from the second step 200 with a low salinity fourth permeate from the third NF system 310 (e.g., from the first array 311 of NF elements in the third NF system 310) in the third step 300 nanofiltration to form a stream (e.g., a 99.2 m³/hr stream) having a salinity (e.g., about 43.3 ppt). This stream may be pressurized to 70 bar and fed to the second RO system 350, which produces water (e.g., at a rate of 36.2 m³/hr) and the fourth retentate (e.g., at a rate of 63 m³/hr) and having a higher salinity (e.g., about 68 ppt) than the combined third permeate and fourth permeate fed to the second RO system 350.

In some embodiments, the fourth retentate from the second RO system 350 is combined with a higher salinity fifth permeate from another portion of the third NF system 310 (e.g., from the second array 312 of NF elements in the third NF system 310) to form a feed (e.g., about 127.8 m³/hr) for the third NF system 310 having a higher salinity (e.g., about 83.7 ppt) than the salinity (e.g., about 48.8 ppt) of the third permeate, the salinity (e.g., about 43.3 ppt) of the feed for the second RO system 350, and/or the salinity (e.g., about 68 ppt) of the fourth retentate output by the second RO system 350. The third NF system 310 may include multiple (e.g., three) arrays of NF elements. In some embodiments, the first array 311 of NF elements of the third NF system 310 has 18 banks of elements with 8 elements in series per bank. This first array 311 of NF elements in the third NF system 310 may produce (e.g., at about 57.6 m³/hr) the fourth permeate having a salinity (e.g., about 39.4 ppt) lower than the feed for the first array of NF elements 311 in the third NF system 310. This first array 311 of NF elements in the third NF system 310 also may produce (e.g., about 70.2 m³/hr) a retentate having a salinity (e.g., about 120 ppt) higher than the salinity (e.g., about 48.8 ppt) of the third permeate, the salinity (e.g., about 43.3 ppt) of the feed for the second RO system 350, the salinity (e.g., about 68 ppt) of the fourth retentate output by the second RO system 350, and/or the salinity (e.g., about 83.7 ppt) of the feed for the first array 311 of NF elements in the third NF system 310.

The retentate from the first array 311 of NF elements in the third NF system 310 may be combined with the (high salinity) second permeate (B) from the second step 200 to feed the second array 312 of NF elements in the third NF system 310. A sixth permeate from the third array 313 of NF elements of the third NF system 310 also may be combined with at least one (e.g., both) of second permeate (B) and the retentate from the first array 311 of NF elements of the third NF system 310 to create a feed (e.g., about 98 m³/hr) for the second array 312 of NF elements in the third NF system 310 having a higher salinity (e.g., about 131 ppt) than the retentate first array 311 of NF elements in the third NF system 310. The second array 312 of NF elements in the third NF system 310 may include 9 banks of NF in parallel with 18 elements in series per bank. The second array 312 of NF elements of the third NF system 310 may produce (e.g., about 64.8 m³/hr) a fifth permeate having a salinity (e.g., about 99 ppt) less than the salinity (e.g., about 131 ppt) of the feed for the second array 312 of NF elements in the third NF system 310. The second array 312 of NF elements of the third NF system 310 also may produce (e.g., about 33.2 m³/hr) a retentate having a salinity (e.g., about 194 ppt) that is greater than the salinity (e.g., about 131 ppt) of the feed for the second array 312 of NF elements in the third NF system 310.

The retentate from the second array 312 of NF elements of the third NF system 310 may be fed to the third (e.g., last) array 313 of NF elements in the third NF system 310, which may include 3 banks in parallel and with each bank having 18 elements in series. The third array 313 of NF elements in the third NF system 310 may produce (e.g., about 21.6 m³/hr) a sixth permeate having a salinity (e.g., about 164 ppt) that is less than the salinity (e.g., about 194 ppt) of the feed for the third array 313 of NF elements in the third NF system 310, but greater than the salinity (e.g. about 139 ppt) of the second permeate (B) and greater than the salinity (e.g., about 48.8) of the third permeate (C). The third array 313 of NF elements in the third NF system 310 also may produce (e.g., about 11.6 m³/hr) a fifth (or final) retentate having a salinity (e.g. about 250 ppt) at least about four times or five times greater than the salinity of the initial solution, at least about 1.5 times greater than the salinity (e.g. about 139 ppt) of the second permeate, and/or at least about four or five times greater than the salinity (e.g., about 48.8) of the third permeate (C). The magnesium concentration in the final retentate may be about 0.1 ppt or less.

Considering the system as a whole, in an example, 238 m³/hr seawater is separated into 150 m³/hr water, 11.6 m³/hr 250 ppt NaCl, 3.4 m³/hr mixed salts at 230 ppt, and 72 m³/hr of mixed salt at 89 ppt. The total power consumption, assuming 80% efficient pumps, is 1180 KW.

Features from any of the disclosed embodiments may be used in combination with one another, without limitation. In addition, other features and advantages of the present disclosure will become apparent to those of ordinary skill in the art through consideration of the following detailed description and the accompanying drawings.

As used herein, the term “about” or “substantially” refers to an allowable variance of the term modified by “about” or “substantially” by ±10% or ±5%. Further, the terms “less than,” “or less,” “greater than,” “more than,” or “or more” include, as an endpoint, the value that is modified by the terms “less than,” “or less,” “greater than,” “more than,” or “or more.”

While various aspects and embodiments have been disclosed herein, other aspects and embodiments are contemplated. The various aspects and embodiments disclosed herein are for purposes of illustration and are not intended to be limiting.

1. A method of producing desalinated seawater, the method comprising:
nanofiltrating seawater to reduce calcium, magnesium, and sulfate therein;
introducing permeate from the nanofiltration step as a feed to a first reverse osmosis (RO) system followed by a first progressive nanofiltration array, thereby forming a lower salinity permeate and a higher salinity permeate having a salinity greater than the lower salinity permeate;
feeding the lower salinity permeate to a second RO system, thereby forming a retentate; and
feeding the retentate from the second RO system to a second progressive nanofiltration system that concentrates brine in the retentate to within at least a predetermined salinity.

2. (canceled)

3. The method of claim 1, further comprising:
feeding the higher salinity permeate to the second progressive nanofiltration system;
feeding retentate from the first RO system to a first array in the first progressive nanofiltration system, thereby producing a retentate and a permeate;
feeding retentate from the first array in the first progressive nanofiltration system to a second array in the first progressive nanofiltration system, thereby producing a retentate and a permeate;
combining the permeate from the first array in the first progressive nanofiltration system with the permeate from the second array in the first progressive nanofiltration system to form the lower salinity permeate; and
feeding the retentate from the second array in the first progressive nanofiltration system to a third array in the first progressive nanofiltration system, thereby forming a retentate and the higher salinity permeate.

4. The method of claim 1, further comprising:
wherein feeding the retentate from the second RO system to a second progressive nanofiltration system that concentrates brine in the retentate to within at least a predetermined salinity includes feeding at least the retentate from the second RO system to a first array of the second progressive nanofiltration system, thereby forming a retentate and a permeate;
combining the higher salinity permeate with at least the retentate from the first array of the second progressive nanofiltration system;
feeding the higher salinity permeate and at least the retentate from the first array second progressive nanofiltration system, as combined, to a second array in the second progressive nanofiltration system, thereby forming a permeate and a retentate; and
feeding the retentate from the second array of the second progressive nanofiltration system to a third array in the second progressive nanofiltration system, thereby producing a permeate and the retentate within at least the predetermined salinity.

5. The method of claim 4, further comprising:
combining the permeate from the first array of the second progressive nanofiltration system with the lower salinity permeate;
feeding the permeate from the first array of the second progressive nanofiltration system and the lower salinity permeate, as combined, to the second RO system;
combining the permeate from the second array of the second progressive nanofiltration system with the retentate from the second RO system;
wherein feeding at least the retentate from the second RO system to a first array of the second progressive nanofiltration system includes feeding the permeate from the second array the second progressive nanofiltration system and the retentate from the second RO system, as combined, to the first array of the second progressive nanofiltration system;
combining the permeate from the third array of the second progressive nanofiltration system with the higher salinity permeate and retentate from the first array of the second progressive nanofiltration system; and
wherein feeding the higher salinity permeate and at least the retentate from the first array second progressive nanofiltration system, as combined, to a second array in the second progressive nanofiltration system includes feeding the higher salinity permeate, the retentate from the first array second progressive nanofiltration system, and the permeate from the third array of the second progressive nanofiltration system, as combined, to the second array in the second progressive nanofiltration system.

6. A system for reducing at least one of magnesium, calcium and/or sulfate from sodium chloride brine, the system comprising:
a first nanofiltration (NF) system positioned to receive at least filtered seawater fed by a pump, and configured to produce a first retentate and a first permeate;
a first reverse osmosis (RO) system positioned to be fed the first permeate from the first NF system and configured to produce at least a second retentate and desalinated water;
a second NF system positioned to be fed the second retentate from the first RO system and configured to produce one or more additional permeates;
a second RO system positioned to be fed at least one permeate of the one or more additional permeates from the second NF system to produce at least a fourth retentate and additional desalinated water; and
a third NF system positioned to be fed at least the fourth retentate from the second RO system to produce one or more further permeates and a final retentate that is substantially free of divalent ions.

7. (canceled)

8. The system of claim 6, wherein:
the one or more additional permeates produced by the second NF system include multiple permeates and the second NF system includes multiple arrays of NF elements configured to produce the multiple permeates;
the multiple arrays of NF elements of the second NF system configured to produce the multiple permeates include:
a first array of NF elements positioned to be fed the second retentate from the first RO system and configured to produce a retentate and a permeate;
a second array of NF elements positioned to be fed the retentate produced by the first array of NF elements of the second NF system and configured to produce a retentate and a permeate; and
a third array of NF elements positioned to be fed the retentate produced by the second array of NF elements of the second NF system and configured to produce a third retentate and a second permeate; and
the system is configured to combine the permeate from the first array of NF elements in the second NF system with the permeate from the second array of NF elements in the second NF system to form a third permeate.

9. The system of claim 8, wherein:
the first array of NF elements includes multiples banks in parallel and multiple elements in series per bank of the multiple banks of the first array of NF elements;
the second array of NF elements includes multiple banks in parallel and multiple elements in series per bank of the multiple banks of the second array of NF elements; and
the third array of NF elements includes multiple elements in series.

10. The system of claim 9, wherein the second array of NF elements includes fewer banks in parallel than the first array of NF elements and more elements in series per bank than the first array of NF elements, and wherein the third array of NF elements includes more elements in series than the first array of NF elements.

11. (canceled)

12. The system of any of claim 8, wherein the at least one permeate fed to the second RO system from the second NF system includes the third permeate from the second NF system.

13. The system of claim 12, wherein the one or more further permeates produced by the third NF system include multiple further permeates and the third NF system includes multiple arrays of NF elements configured to produce the multiple further permeates.

14. The system of claim 13, wherein the multiple arrays of NF elements of the third NF system configured to produce the multiple further permeates include:
a first array of NF elements positioned to be fed at least the fourth retentate from the second RO system and configured to produce a retentate and a fourth permeate;
a second array of NF elements positioned to be fed at least the retentate produced by the first array of NF elements of the third NF system and configured to produce a retentate and a fifth permeate; and
a third array of NF elements positioned to be fed at least the retentate produced by the second array of NF elements of the third NF system and configured to produce a sixth permeate and the final retentate that is substantially free of the divalent ions.

15. The system of claim 14, wherein:
the first array of NF elements of the third NF system includes multiples banks in parallel and multiple elements in series per bank of the multiple banks of the first array of NF elements of the third NF system;
the second array of NF elements of the third NF system includes multiple banks in parallel and multiple elements in series per bank of the multiple banks of the second array of NF elements of the third NF system; and
the third array of NF elements of the third NF system includes multiple banks in parallel and multiple elements in series per bank of the multiple elements of the third array of NF elements of the of the third NF system.

16. The system of claim 15, wherein:
the second array of NF elements of the third NF system includes fewer banks in parallel than the first array of NF elements of the third NF system and more elements in series per bank than the first array of NF elements of the third NF system; and
the third array of NF elements of the third NF system includes fewer banks in parallel than the second array of NF elements of the third NF system and more elements in series than the first array of NF elements of the third NF system.

17. The system of claim 14, wherein the system is configured to combine the fourth permeate from the first array of NF elements in the third NF system with the third permeate to feed the second RO system.

18. The system of claim 14, wherein the system is configured to combine the fifth permeate from the second array of NF elements in the third NF system with the fourth retentate from the second RO system to feed the first array of NF elements in the third NF system.

19. The system of claim 14, wherein the system is configured to combine the second permeate from the third array of NF elements in the second NF system with the retentate from the first array of NF elements in the third NF system to feed the second array of NF elements in the third NF system.

20. The system of claim 14, wherein the system is configured to combine the sixth permeate from the third array of NF elements in the third NF system with the retentate from the first array of NF elements in the third NF system to feed the second array of NF elements in the third NF system.

21. The system of claim 14, wherein the system is configured to combine the second permeate from the third array of NF elements in the second NF system, the sixth permeate from the third array of NF elements in the third NF system, and the retentate from the first array of NF elements in the third NF system to feed the second array of NF elements in the third NF system.

22. The system of claim 6, wherein the system is configured to combine the filtered seawater with an antiscalant before the filtered seawater is fed to the first NF system.

23. A method for reducing at least one of magnesium, calcium and/or sulfate from sodium chloride brine, the method comprising:
feeding at least filtered seawater to a first nanofiltration (NF) system, thereby producing a first retentate and a first permeate;
feeding the first permeate from the first NF system to a first reverse osmosis (RO) system, thereby producing at least a second retentate and desalinated water;
feeding the second retentate from the first RO system to a second NF system, thereby producing one or more additional permeates;
feeding at least one permeate of the one or more additional permeates from the second NF system to a second RO system, thereby producing at least a fourth retentate and additional desalinated water; and
feeding at least the fourth retentate from the second RO system to a third NF system, thereby producing one or more further permeates and a final retentate that is substantially free of divalent ions.

24. The method of claim 23, wherein feeding a second retentate from the first RO system to a second NF system, thereby producing one or more additional permeates includes:
feeding the second retentate from the first RO system to the second NF system including multiple arrays, thereby producing multiple permeates.

25. The method of claim 24, further comprising:
wherein feeding the second retentate from the first RO system to the second NF system including multiple arrays, thereby producing multiple permeates includes:
feeding the second retentate from the first RO system to a first array of NF element of the second NF system, thereby producing a retentate and a permeate;
feeding the retentate from the first array of NF elements of the second NF system to a second array of NF elements in the second NF system, thereby producing a retentate and a permeate; and
feeding the retentate from the second array of NF elements of the second NF system to a third array of NF elements in the second NF system, thereby producing a third retentate and a second permeate; and
combining the permeate from the first array of NF elements in the second NF system with the permeate from the second array of NF elements in the second NF system, thereby producing a third permeate.

26. The method of claim 25, wherein:
the first array of NF elements includes multiples banks in parallel and multiple elements in series per bank of the multiple banks of the first array of NF elements;
the second array of NF elements includes multiple banks in parallel and multiple elements in series per bank of the multiple banks of the second array of NF elements; and
the third array of NF elements includes multiple elements in series.

27. The method of claim 26, wherein the second array of NF elements includes fewer banks in parallel than the first array of NF elements and more elements in series per bank than the first array of NF elements, and wherein the third array of NF elements includes more elements in series than the first array of NF elements.

28. (canceled)

29. The method of claim 25, wherein feeding at least one permeate of the one or more additional permeates from the second NF system to a second RO system includes feeding at least the third permeate from the second NF system to the second RO system.

30. The method of claim 29, wherein feeding at least the fourth retentate from the second RO system to a third NF system, thereby producing one or more further permeates includes:
feeding the fourth retentate from the second RO system to the third NF system including multiple arrays, thereby producing multiple further permeates.

31. The method of claim 30, wherein feeding the fourth retentate from the second RO system to the third NF system including multiple arrays, thereby producing multiple further permeates includes:
feeding at least the fourth retentate from the second RO system to a first array of NF element of the third NF system, thereby producing a retentate and a fourth permeate;
feeding the retentate from the first array of NF elements of the third NF system to a second array of NF elements in the third NF system, thereby producing a retentate and a fifth permeate; and
feeding the retentate from the second array of NF elements of the third NF system to a third array of NF elements in the third NF system, thereby producing a sixth permeate and the final retentate that is substantially free of divalent ions.

32. The method of claim 31, wherein:
the first array of NF elements of the third NF system includes multiples banks in parallel and multiple elements in series per bank of the multiple banks of the first array of NF elements of the third NF system;
the second array of NF elements of the third NF system includes multiple banks in parallel and multiple elements in series per bank of the multiple banks of the second array of NF elements of the third NF system; and
the third array of NF elements of the third NF system includes multiple banks in parallel and multiple elements in series per bank of the multiple elements of the third array of NF elements of the of the third NF system.

33. The method of claim 32, wherein:
the second array of NF elements of the third NF system includes fewer banks in parallel than the first array of NF elements of the third NF system and more elements in series per bank than the first array of NF elements of the third NF system; and
the third array of NF elements of the third NF system includes fewer banks in parallel than the second array of NF elements of the third NF system and more elements in series than the first array of NF elements of the third NF system.

34. The method of claim 31, further comprising:
combining the fourth permeate from the first array of NF elements in the third NF system with the third permeate; and
wherein feeding at least one permeate of the one or more additional permeates from the second NF system to a second RO system includes feeding the fourth permeate and the third permeate as combined to the second RO system.

35. The method of claim 31, further comprising:
combining the fifth permeate from the second array of NF elements in the third NF system with the fourth retentate from the second RO system; and
wherein feeding at least the fourth retentate from the second RO system to a first array of NF element of the third NF system includes feeding the fifth permeate and the fourth retentate as combined to the first array of NF elements in the third NF system.

36. The method of claim 31, further comprising:
combining the second permeate from the third array of NF elements in the second NF system with the retentate from the first array of NF elements in the third NF system; and
feeding the second permeate and the retentate from the first array of NF elements in the third NF system as combined to the second array of NF elements in the third NF system.

37. The method of claim 31, further comprising:
combining the sixth permeate from the third array of NF elements in the third NF system with the retentate from the first array of NF elements in the third NF system; and
feeding the sixth permeate and the retentate from the first array of NF elements in the third NF system as combined to the second array of NF elements in the third NF system.

38. The method of claim 31, further comprising:
combining the second permeate from the third array of NF elements in the second NF system, the sixth permeate from the third array of NF elements in the third NF system, and the retentate from the first array of NF elements in the third NF system; and
feeding the second permeate, the sixth permeate, and the retentate from the first array of NF elements in the third NF system as combined to the second array of NF elements in the third NF system.

39. The method of claim 23, further comprising combining the filtered seawater with an antiscalant before feeding the filtered seawater to the first NF system.
